(19) United States
(12) Patent Application Publication
(10) Pub. No.: US 2005/0282604 A1
(43) Pub. Date: Dec. 22, 2005

(54) Method of playing a poker game using fixed wagering

(76) Inventors: Conrad B. Hernandez, (US); Mark H. Jones, (US)

Correspondence Address: CONRAD B. HERNANDEZ, P O Box 85484, Tucson, AZ, 85754, US

(21) Appl. No.: 11/154,439

(22) Filed: Jun. 16, 2005

Related U.S. Application Data
(60) Provisional application No. 60/580,130, filed on Jun. 17, 2004.

(51) Int. Cl. G06F 17/00; A63F 9/24

(52) U.S. Cl. 463/13

(57) ABSTRACT

A method for playing a poker game is introduced herein that provides monetary protection for the non skilled poker player while competing with highly skilled poker players. The method also provides leveling the playing field for non skilled poker players competing against other non skilled poker players.

### CROSS-REFERENCE TO RELATED APPLICATION

This application claims the benefit of U.S. Provisional Application No. 60/580,130, filed Jun. 17, 2004.

### BACKGROUND OF THE INVENTION

1. Field of Invention

The present invention is directed to poker card games and, more particularly, to the fixed wagering methods used therein.

2. Description of the Prior Art

Card games are considered by many to be educational, stimulating, and exciting social activities. Many of the more popular card games are designed to mentally involve as well as test the strategic abilities of each individual player. These same characteristics are often further enhanced when the card game is combined with an opportunity for placing wagers. A successful casino card game must hold the interest of the players in both a monetary and non-monetary manner. In addition to enjoying the play of the game, the players must also entertain the perception that each of them has a possibility of winning the wager. There must be something inherent in the game or its manner of play that involves a player, without regard to financial gain and/or despite the occurrence of wagers lost. For some players, this inherent characteristic might be the thrill generated by the chance that “luck” will visit the player. For other players, card games tend to emphasize a competitive aspect that appeals to card players that are more confident of their skill level and less reliant on “luck.” Games based upon stud poker have attained enormous popularity as evidenced by the recent exposure on television and the internet. The success of stud poker is at best partially based on the game's simplicity, i.e., there is widespread public knowledge of the game rules available in bookstores and in the internet. Poker card rooms are considered to be game areas for players highly skilled in the art of poker. Consequently there are many novice players who would enjoy an evening of fun and entertainment playing a game of poker with other players that are more on their level. What is needed is to have two separate levels of poker play. The present play of poker is highly identifiable by the skilled level used by the players and as such would be the dominating level. Non skilled players would make up the second level. Tournaments in the non skilled level would also create viewing excitement and create additional revenue for casinos by having games for players during non prime hours. The present invention does not attempt to modify the rules of play for present poker games. Instead it tries to protect the non skilled player from the sharks vs fishes environment to one of a controlled environment. New poker games, submitted during this poker craze, in which patent designs are submitted in an attempt to modify the traditional, popular, and familiar poker games that have been around for years, are at best fighting an upside battle. It is conceivable that attempted deviations to the present poker standards will be unobtainable in the near future. Other objects, features, and advantages of the invention should be apparent from the following description of the preferred embodiment thereof as illustrated in the accompanying drawings.

### SUMMARY OF THE INVENTION

In the view of the foregoing monetary disadvantages inherent in the known playing levels associated with the two types of player, skilled vs non skilled now present in the prior art, the present invention provides an improved method of play for providing the non skilled players an opportunity to share in the fun and entertainment provided in poker play competition by lowering the monetary level exposure. Towards this end the method directs the use of fixed betting and the eliminating the use of having blinds; raises; checks and raises; bluffing techniques; the need for tells; the use of dark glasses, etc. in the play of a poker game. There has thus been outlined, rather broadly, the more important features of the invention in order that the detailed description thereof that follows may be better understood, and in order that the present contribution to the art may be better appreciated. There are additional features of the invention that will be described hereinafter. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar they do not depart from the spirit and scope of the present invention. Even still another object of the present invention is to provide a new and improved card game and method of play for providing a unique poker game that varies from normal poker games. It is another object of the present invention to provide a new and improved card game and method of play which may be easily and efficiently marketed. These together with other objects of the invention, along with the various features of novelty which characterize the invention, are pointed out with particularity in the claims annexed to and forming a part of the disclosure. For a better understanding of the invention, its operating advantages and the specific objects attained by its uses, reference should be had to the accompanying example formed as a variation of the poker game TEXAS HOLD'EM

### BRIEF DESCRIPTION OF THE DRAWINGS

FIG. 1 is a perspective view showing a playing surface arranged in accordance with the principles of the present invention;

FIG. 2 is a diagrammatic plan view of a typical playing area layout for the card game system described by the present invention.

### DESCRIPTION OF THE EMBODIMENT

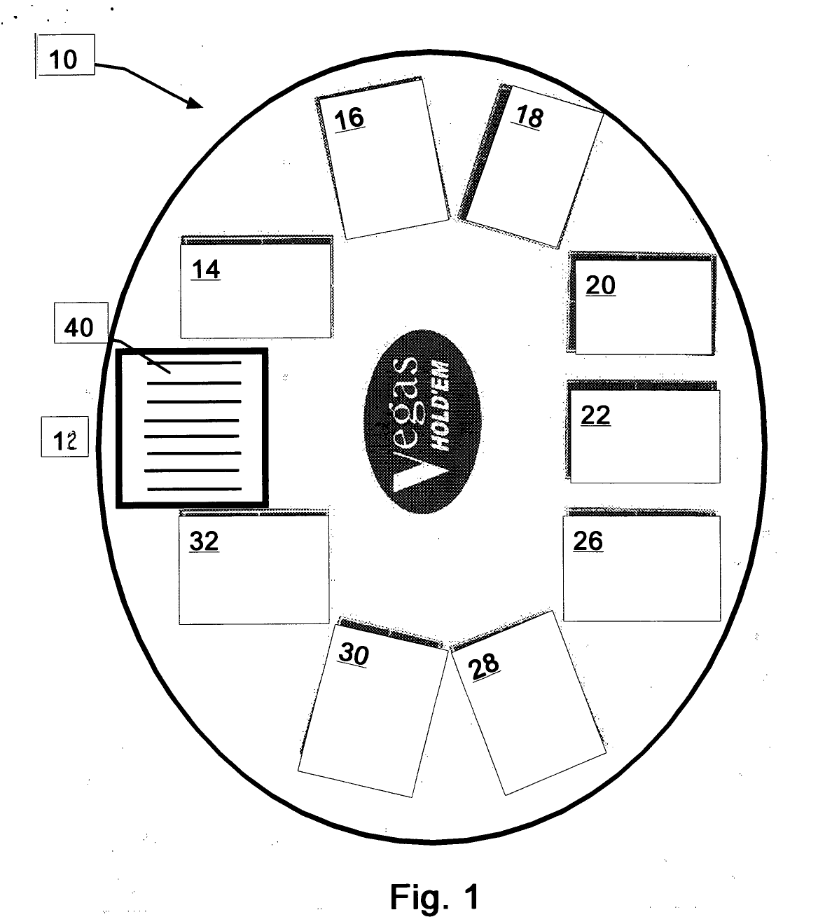

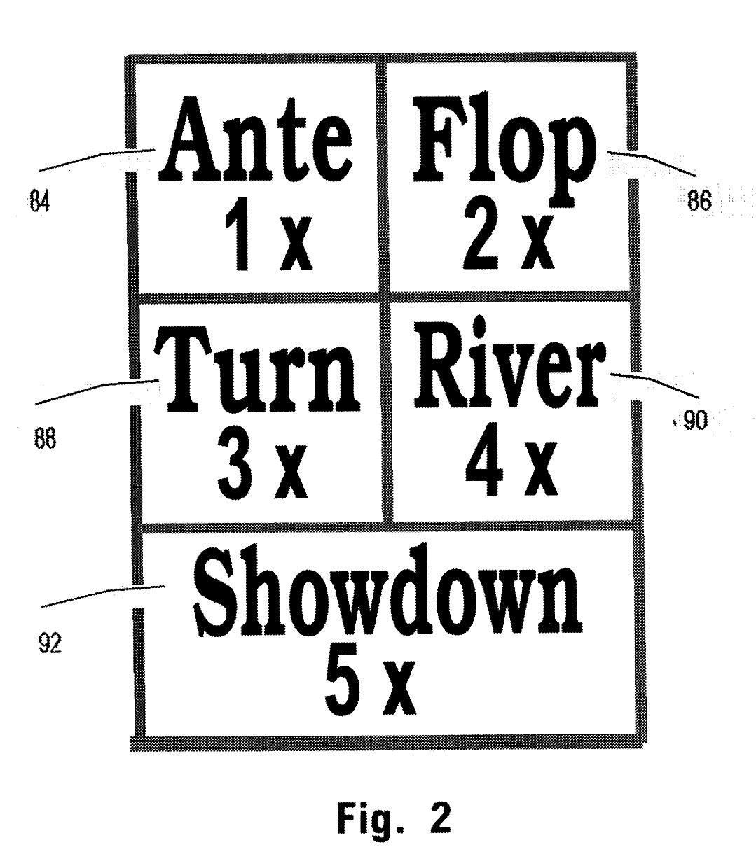

As used in this specification, the term “casino card game” refers to a card game in which two or more players compete against one another. Additionally, although the play of the game will be illustrated by making reference to a specific game layout, it should be understood and appreciated that the playing card casino game system of the present invention can be played with a different layout, or without the use of a layout, and still be within the scope of the present invention. Reference is now made to the drawings. In FIG. 1 there is shown a gaming table layout arranged in accordance with the principle of the present invention, and designated generally by reference numeral 10. In a preferred embodiment, the gaming table layout 10 is generally oblong in shape, and is preferably sized to have approximately the same dimensions as a conventional casino gaming table layout of the type normally used to play poker. A dealer position 12 is centrally located along a linear, rear edge of the gaming table layout 10. A plurality of wagering areas 14, 16, 18, 20, 22, 24, 26, 28, 30, 32 are evenly spaced apart along the oval periphery 10. As so located, the plurality of wagering areas 14-32 are arranged opposite the dealer position 12, permitting the dealer to be within an arm's length of each of the player's wagering areas of the game, and for each of the players in turn to be within an arm's length of the wagering area. An area is provided immediately adjacent the dealer position 12 for placement of a chip tray 40. Casino games are typically played using chips rather than actual currency, and the chip tray 40 is available for use by the dealer primarily to provide chip value changing services. In a preferred embodiment, the gaming table layout 10 is formed of a felt or like material, and the various defined areas are placed on the playing surface by a silk screen process. The gaming table 10 shown in FIG. 1 depicts a layout for 9 players. FIG. 2 provides some additional details regarding the wagering areas. Each of the plurality of wagering areas 14-32 are substantially identical to that depicted in FIG. 2 and each wagering area consists of a plurality of betting fields 84-92. Each of the betting fields bear indicia providing the fixed betting amount for that betting field. As will be more fully explained hereinafter, the betting fields will come into play sequentially as follows: The 1st wagering placement is the Ante requiring a single wagering unit. (The unit being the selected minimum wager for that game) As an example $1 will be used to illustrate the process. The 2nd wagering event to take place is the Flop requiring 2 wagering units ($2 in this case). The 3rd wagering event is the Turn requiring three wagering units ($3). The 4th wagering event is the River bet requiring four wagering units ($4) and the 5th and last wagering event is the Showdown bet requiring five wagering units ($5). To describe the operation of the invention, set forth in the following are the rules of play: At commencement, the Dealer advises the players with a sweeping hand motion to “place antes.” The Players place a predetermined bet in the “ante 1×” betting square in front of them. As the players place their bets the dealer proceeds to shuffle and cut the cards. The Dealer deals two face down cards to each player and advises the players to place their “flop” bets. The Players after looking at their two cards may elect to drop-out (fold) or continue by placing the predetermined bet in the “flop 2×” betting square. Anytime a players folds his hand he must discard the two cards he is holding. The Dealer will in turn collect all the bets from that players betting squares. All bets must be placed in order on all rounds starting with the player at the right of the dealer button. After the Dealer assures that all players have acted, the Dealer burns 1 card and places three community cards face up in the middle of the layout. These cards now serve as each players fifth card. The Dealer advises the players to place their “turn” bets. The players again may now elect to fold or continue play by placing the predetermined bet in the “turn 3×” betting square. The Dealer burns 1 card and places a single face-up community card that serves as each players sixth card. The Dealer now advises the players to place their “river” bets. The player may now elect to fold or continue play by placing a predetermined bet in the “river 4×” betting square. The Dealer burns 1 card and places the final single face up community card that serves as each players seventh card. The remaining players have in their hands the two initial cards which in combination with the five community cards provide the player with a possible winning hand from which to determine whether the poker hand that they are holding merits one final bet. The players that determine that their hand is the winning hand place a predetermined final bet in the “showdown 5×” betting square. The Dealer collects all the bets from the betting squares of the remaining players and places them in the center of the table. The Players place the two cards that they are holding face up near their betting boxes and declare their poker hands. If they declare an incorrect poker hand the dealer will report the corrected hand. Their is no penalty for reporting an incorrect poker hand as the “cards speak for themselves.” The player who compiles the best five card poker hand made by combining his two hole cards with the five community cards is declared the winner and awarded the pot. If there is more than one declared winner the pot will be equally distributed among them. My invention has been disclosed in terms of a preferred embodiment thereof, which provides an improved playing card casino game system of great novelty and utility. Various changes, modifications, and alterations in the teachings of the present invention may be contemplated by those skilled in the art without departing from the intended spirit and scope thereof. It is intended that the present invention encompass such changes and modifications.

1. A method of playing any poker card game using a unique form of play comprising the steps of:
providing a gaming table layout, generally oblong in shape, and preferably sized to have approximately the same dimensions as a conventional casino gaming table layout of the type normally used to play poker;
providing a plurality of betting squares in front of each player position;
providing a plurality of indicia of conventional playing cards;
providing a dealer;
providing a dealer button;
providing a house table limit;
providing at least two players with an opportunity to place a wager.

2. The method of claim 1 wherein said betting squares typically number five

3. The method of claim 2 wherein said betting squares each contain a plurality of indicia of the numbers 1, 2, 3, 4, and 5.

4. The method of claim 2 wherein said betting squares numbers one and two are placed on the layout and are viewed by the player as reading from left to right.

5. The method of claim 2 wherein said betting squares numbers three and four are placed on the layout closer to the player and are viewed as reading from left to right.

6. The method of claim 2 wherein said betting square number five is placed on the layout closest to the player.

7. The method of claim 1 wherein appropriate said betting square number indicia is used in combination with said house table limit to determine the proper bet required.

8. The method of claim 1 wherein playing different forms of draw poker games requiring each of the players to use fixed betting.

9. The method of claim 1 wherein playing different forms of stud poker games requiring each of the players to use fixed betting.

10. The method of claim 1 wherein playing different forms of poker games requiring each of the players to use fixed betting.

11. The method of claim 1 wherein the desired type of card game is poker.

12. The method of claim 11 wherein no raises are allowed.

13. The method of claim 11 wherein no player checking is allowed.

14. The method of claim 11 wherein the card game does not allow use of blind wagers.

15. The method of claim 11 wherein the card game does not allow the use of card checking and raising to be used.
